(19) United States
(12) Patent Application Publication
(10) Pub. No.: US 2005/0011415 A1
(43) Pub. Date: Jan. 20, 2005

(54) Material comprising gypsum and blast furnace slag, a process and an installation of making the same

(76) Inventor: Gaspar Herban, Hunedoara (RU)

Correspondence Address: Herban Gaspar, Str George Enescu NR 9 AP 18, Hunedoara, 331056, RO

(21) Appl. No.: 10/495,996

(22) PCT Filed: Jan. 25, 2002
(86) PCT No.: PCT/RO02/00001

(30) Foreign Application Priority Data
Dec. 3, 2001 (RO) A2001 01285

(51) Int. Cl. C04B 5/00

(52) U.S. Cl. 106/789

(57) ABSTRACT

The invention refers to a recovery proceeding which consists in achieving a thermic transfer from slag to a calcium sulphate dihydrate rock, with the maximum dimension of the granules of 20 mm., in a temperature interval of 100-145° C., into the tank of an autoclave, to a bigger pressure than the saturation pressure of the steams, which corresponds to the temperature of the slag-rock mixture in the autoclave, obtaining, after processing, new types of binders. The installation by which the proceeding is achieved is endowed with equipment that consists in a slag pot (s), the inclined slag runner (1), the bunker (2) with feeding and dosing equipment (3), the drain (4), designed to attain, for the raw materials, impact speeds of 4-6 m/s and impact angles of 40-70°, the autoclave with tank (5), evacuation door (6) and lid (7), classic equipment used in the building materials industry. The new types of binders, according to the invention, named high strength hydraulic plaster and much slag-high strength hydraulic plaster, have hydraulic properties and high strength at compression with values which are approximately of 25-40 MN/m².

The invention refers to a recovery proceeding of the physical heat from the liquid blast furnace slag by its utilization in a thermo-technological process to obtain some semiproducts from which, through specific processing in the building materials industry, binders are obtained, to an installation by which the recovery proceeding is achieved, as well as to new types of binders obtained by the application of the proceeding and recovery installation.

It is common knowledge that the liquid blast furnace slag is submitted, generally, to a technological process of water cooling obtaining granulated blast furnace slag which is used as addition to the some Portland cements manufacture and in various Portland cement concrete.

There are technical solutions of power turning to account of the physical heat from slag.

There are recovery proceedings of the physical heat from slag by its use in the manufacture process of the mineral wool.

There is a recovery proceeding of the physical heat from slag by which a mixture is achieved from liquid slag and gypsum rock for obtaining binders.

There are proceedings to obtain binder by mixture of ground granulated slag with gypsum plaster.

There are proceedings to obtain high strength construction plaster.

The disadvantage of these proceedings, of the afferent installations and of the cements named above are:
in the granulation industrial process of the blast furnace slag the all the heat quantity accumulated in the liquid slag is lost, a considerable water quantity being consumed;
supplementary energy consumption in the cement industry to eliminate the humidity of 15-20% contained in the granulated slag;
at the power turning to account of the heat from slag the specialty literature does not indicate industrial applications;
at the turning to account of liquid slag in the manufacture process of the mineral wool, the slag consumption is limited as use to a very small quantity by comparison with the big slag quantity existing in a blast furnace plant;
at the heat recovery from liquid slag by its mixture with crushed gypsum rock, it has been found that the proceeding does not comprise all the assortments of binders possible to be obtained;
in the case of binders obtained by mixture of ground granulated slag with gypsum plaster a high cost of the binders is estimated;
in the case of high strength construction plaster, also, there is a big consumption of fuel and a high cost of the binder.
   The problem which is solved by the invention is the heat recovery from liquid blast furnace slag, heat which has the equivalent value of 60 Kg. conventional fuel/slag ton, as well as the achievement of new binder types which have hydraulic properties and high strength to compression.

The proceeding, in accordance with the invention, eliminates the disadvantages mentioned above by the fact that a heat transfer from slag to a gypsum rock is effected, which contains between 40-96% calcium sulphate dehydrate, crushed, with 20 mm. maximum dimension of the granules, the thermic transfer being unfolded in two phases, a transitory phase to obtain and deposit, in an autoclave, the slag-rock mixture at a maximum average temperature of 140-145° C., and an autoclaving phase unfolded at a temperature interval of 100-145° C. to a bigger pressure than the saturation pressure of the steam which corresponds to the temperature of the slag-rock mixture from autoclave, resulting, by the dehydration of the gypsum and the granulation of the slag with the help of the steam evacuated from gypsum, a semiproduct which, after cooling, is submitted to a fine grinding process obtaining a new binder type named high strength hydraulic plaster with a slag content of 23-33,5% and hemihydrate:slag ratio with values in the interval of 1,2-1,9 or to an autogenous grinding, classifying and fine grinding process obtaining, besides the binder known as high strength construction plaster, still a new binder type named much slag-high strength hydraulic plaster, where the slag quantity is of minimum 23% and hemihydrate:slag ratio is less than 1,2.

It is very important that the transitory phase last as less as possible in order to diminish at minimum the formation of crystals of β.hemihydrate by dehydration of the gypsum at atmospheric pressure.

The installation, in accordance with the invention, is formed by recovery installation itself, named semiproducts installation, and semiproducts processing installation, and is constituted from a slag pot out of which the liquid slag is diverted in an inclined slag runner, the bunker for the crushed gypsum rock, feeding and dosing equipment and a drain through which the gypsum rock is introduced into the liquid slag jet, the slag-rock mixture being deposited in an autoclave with thermic insulated walls and a protection metallic blindage, the lid of the autoclave being endowed with adjustment device of the steam quantity evacuated from the autoclave into atmosphere for the maintenance of the imposed pressure, measure and checking devices of the temperature and pressure from the autoclave and a safety valve, the tank of the autoclave having at the lower part an evacuation door of the semiproduct, conveyers, specific equipment from the building materials industry for obtaining the binders.

The new binder types obtained, in accordance with the invention, have hydraulic properties due to the blast furnace slag content and high strength to compression due to the dihydrated gypsum content obtained in the conditions of imposed temperature and pressure, conditions in which the α.hemihydrate crystals are formed, having smaller form and being more compact as compared to β.hemihydrate crystals, obtained by the gypsum dehydration at atmospheric pressure, which are bigger and have a sponge aspect. Because of the form and more compact structure of the a type crystals, the high strength hydraulic plaster requires at hydration a less water quantity and it gives more compact and resistant products as compared to the plaster obtained in the atmospheric pressure conditions.

The compressive strength of the high strength construction plaster, also named alpha-calcium sulphate hemihydrate plaster, obtained by classic proceeding, is after one day of 9-24 MN/² and after 7 days of 25-40 MN/m², having high values as compared to the strength of the common construction plaster, also named plaster of Paris or beta-calcium sulphate hemihydrate plaster, which has the strength value after 7 days of 7-9 MN/m². Such high value of the strength are maintained also in the case of the new binders, high strength hydraulic plaster and much slag-high strength hydraulic plaster, and they are even bigger because of the existence into the binder of the mineralogical compounds from blast furnace slag and chemical compounds formed after the hydration of the binder.

By application of the invention the following advantages are obtained:
important increase of the profitableness to the blast furnace plants;
recovery of approximately 95% from the physical heat of the liquid slag;
the elimination of the fuel consumption necessary in the thermic process for the dehydration of the gypsum rock by comparison with the classic proceedings of obtaining plaster;
the elimination of the CO₂, SO₂, a.s.o. emanation corresponding to a consumption of until 800 Kg conventional fuel/used slag ton, equivalent fuel with the necessary fuel for achieving the same binders, by classic methods, contributing to the diminution of the greenhouse effect and acid rains;
the total economization of the consumed water in the blast furnace slag granulation process;
the possibility to use some gypsum rock with little content of CaSO₄.2H₂O;
big capacity installations for heat recovery from liquid blast furnace slag of hundreds and even over a thousand slag tons/day capacities can be achieved;
the possibility to recover the heat from the evacuated steam from the autoclave;
reduced production costs;
the achievement of hydraulic binders with compression strength of 25-40 MN/m² and even bigger;
high strength hydraulic plaster, much slag-high strength hydraulic plaster and high strength construction plaster can be used for the realization of the prefabricated products as blocks, gypsum board, panels and architectural applications, cements, mortars, a.s.o.

Further it is shown an example of the achievement of the proceeding in accordance with the invention in connection with

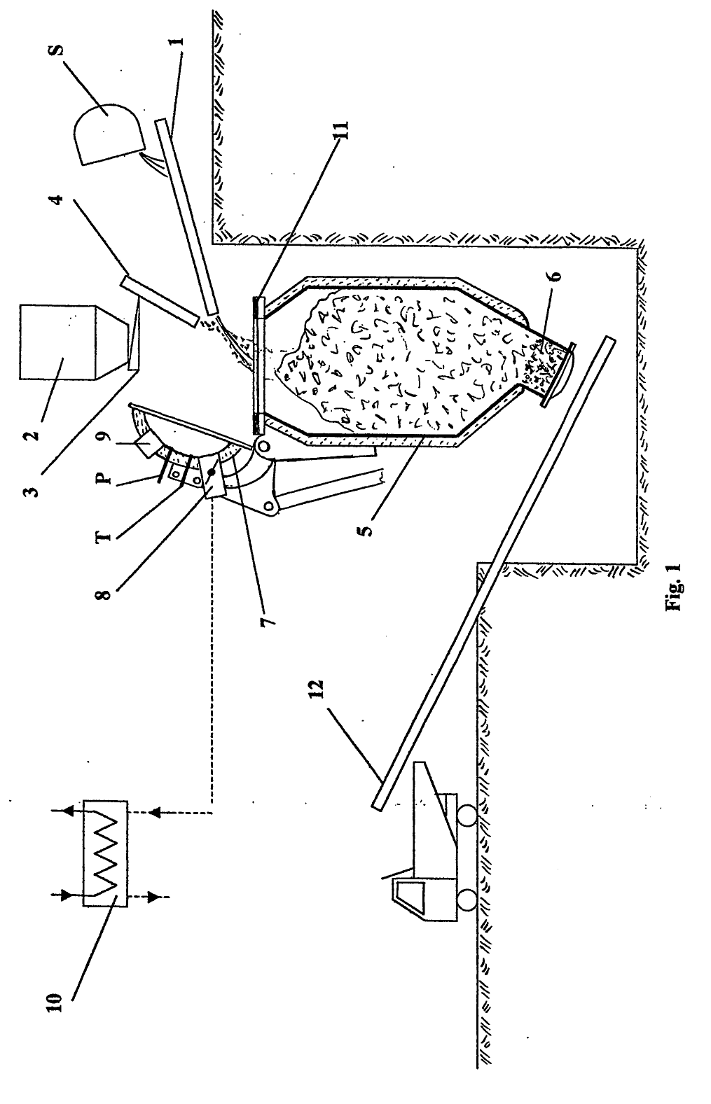

FIG. 1, which represents the technological scheme for the recovery installation itself, named semiproducts installation and

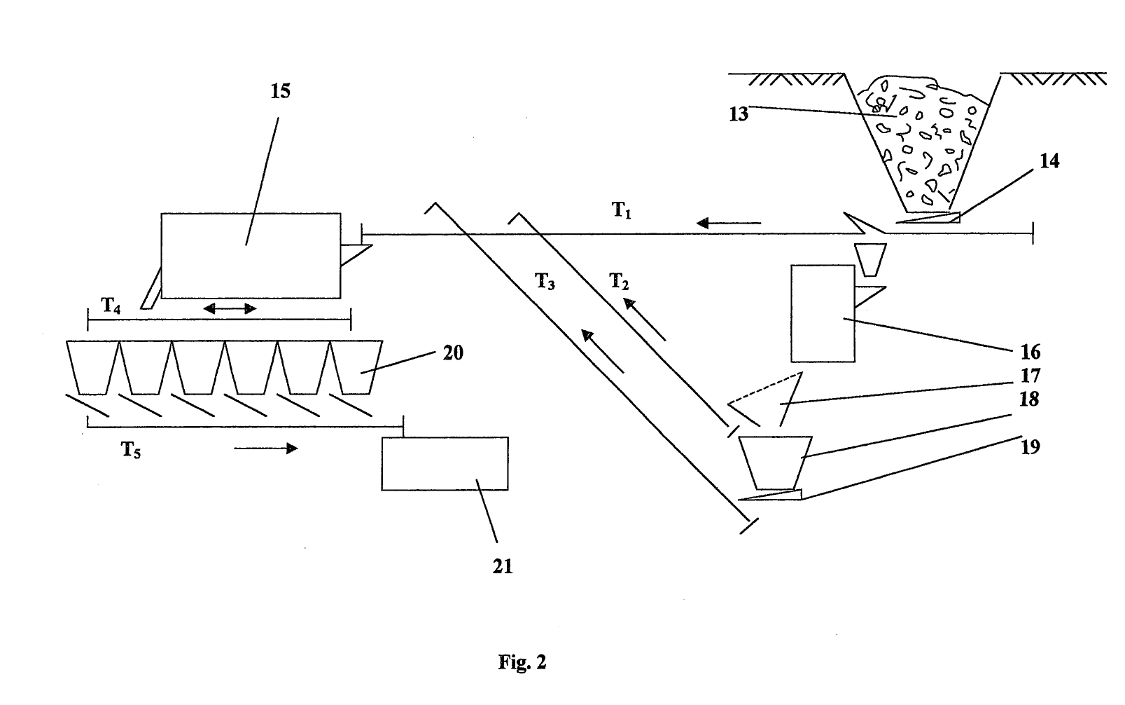

FIG. 2, which represents the processing installation of the semiproducts by fine grinding or autogenous grinding, classifying and fine grinding for obtaining the binders.

The liquid slag, transported with a slag pot s from blast furnace, is diverted in an inclined slag runner 1, in the inferior extremity of the slag runner being placed a bunker 2 for depositing the crushed gypsum rock of a maximum granulation of 20 mm, which is introduced in the liquid slag jet through the feeding and dosing equipment 3 and the drain 4, all being designed so that the slag jet and gypsum rock may have in the impact moment the speeds with values of 4-6 m/s and the impact angles with values of 40-70°. The mechanical mixture slag-gypsum rock falls into the tank 5 of an autoclave which has in the interior a protection metallic blindage, an evacuation door 6 of the semiproduct, and after the slag and gypsum rock are diverted into the tank, the autoclave is closed with the lid 7 endowed with an adjustment device 8 of the steam quantity evacuated into atmosphere, steam which is resulted from the dehydratation of the gypsum, with measure and checking devices of the pressure P and temperature T and with a safety valve 9. The heat of the steam evacuated from autoclave is recovered with the recuperator 10. During the realization and depositing slag-rock mixture into autoclave the superior part of the tank is covered with the protection ring 11 in order to avoid the laying of some pieces of slag and gypsum rock, the ring being eliminated before the lid is mounted.

The dosing of raw materials, liquid slag and gypsum rock, is established so that, depending on the temperature of the liquid slag and the assortment of the gypsum rock, the temperature of the mixture may be of 140-145° C. and after the lid is mounted on the tank, the steam quantity evacuated from autoclave is adjusted with the device 8 so that the pressure into autoclave may be bigger than the saturation pressure of the steam corresponding to the measured temperature of device T. The adjustment of pressure may be done in 1-4 pressure levels or by continuous adjustment.

At the utilization of only one pressure level, the pressure is adjust to the value of 2,6 bar (0,26 N/m²) and is maintained to this value until the temperature in autoclave decreases to 100° C. after which the equalization of the pressure into the autoclave with the atmospheric pressure is done.

At the utilization of all four pressure levels, the pressure into the autoclave is adjusted to the value of 2,6 bar (0,26 MN/m²), being maintained at this value until the temperature in the autoclave decreases to 130° C., followed by a pressure adjustment at the value of 2 bar (0,2 MN/m²) being maintained at this value until the temperature in the autoclave decreases to 120° C., followed by a pressure adjustment at the value of 1,3 bar (0,13 MN/m²) being maintained at this value until the temperature into the autoclave decreases to 110° C., followed by a pressure adjustment at the value of 0,45 bar (0,045 MN/m²) being maintained at this value until the temperature into the autoclave decreases to 100° C., when the pressure into the autoclave is equalized with the atmospheric pressure. The choice of the levels number for the pressure adjustment is done depending on the necessary speed for achieving the dehydratation process of the gypsum, which is determined of gypsum rock type and rock granulation.

The continuous adjustment of the pressure into the autoclave consists in the continuous decrease of the pressure beginning with the value of 2,6 bar (0,26 MN/m²) so that, between the saturation temperature of the steam corresponding to the pressure in the autoclave and the temperature in the autoclave, there may be a difference of minimum 5-10° C. until the temperature into the autoclave decreases at 100° C., following the pressure equalization from the autoclave with the atmospheric pressure.

The semiproducts are evacuated with a conveyer 12 and are expedited to the semiproducts processing installation.

The semiproducts, crushed, if needed, to the maximum fraction of 50 mm because ,during the process, there can appear agglomerations of slag-rock of big dimensions, are deposited into the silos 13 whence with the feeding and dosing equipment 14 and the conveyer T₁ are introduced in the fine grinding mill 15, the binder being deposited with the conveyer T₄ in the bunkers 20 whence are taken by the conveyer T₅ and are introduced in the packing installation. If more types of products are wanted the conveyer T₁ diverts the semiproducts into the autogenous mill 16 whence by pneumatic and/or mechanical classifier 17 there are obtained more assortments which through the bunkers 18, the feeding and dosing equipment 19, the conveyers T₂ and T₃ are introduced in fine grinding mill 15, then the binders are deposited in the bunker 20 whence by the conveyer T₅ are introduced in the packing installation 21.

1. Recovery proceeding of the phisical heat from liquid blast furnace slag, characterized by the fact that a heat transfer is achieved, from liquid slag to a gypsum rock which has a calcium sulfate dihydrate content of 40-96%, in the tank of an autoclave, in two phases, a transitory phase for obtaining and depositing in the autoclave the slag-gypsum rock mixture and an autoclaving phase with the adjustment of the pressure in the autoclave, continuous or in 1-4 pressure levels, obtaining, by the gypsum dehydration and slag granulation with the steams resulted from gypsum, semiproducts whence are making hydraulic binders by fife grinding or autogenous grinding, classifying and fine grinding.

2. Proceeding conformable to claim 1, characterized by the fact that by the mixture of the liquid slag with broken gypsum rock at maximum granulation of 20 mm. and the autoclaving of the mixture are obtained semiproducts containing slag and calcium sulfate alpha hemihydrate.

3. Proceeding conformable to claim 2, characterized by the fact that the semiproduct have a slag content with values in the interval 23-33,5% and calcium sulfate alpha hemihydrate:slag ratio with values in the interval 1,2-1,9.

4. Proceeding conformable to claim 1, characterized by the fact that in transitory phase is achieved the mixture slag-gypsum rock by the impact of the slag jet with gypsum rock, on entering autoclave, the slag and gypsum rock having impact speeds of 4-6 m/s and impact angles of 40-70°.

5. Proceeding conformable to claim 1, characterized by the fact that the autoclaving phase unfolds in the temperature interval of 100-145° C.

6. Proceeding conformable to claim 1, characterized by the fact that the autoclaving phase unfolds in a single pressure level at value of 2,6 bar (0,26 MN/m²), this pressure being maintained until the temperature in the autoclave decreases to 100° C., when the pressure in the autoclave is equalized with the atmospheric pressure.

7. Proceeding conformable to claim 1, characterized by the fact that the autoclaving phase unfolds in four pressure levels by the adjustment of the pressure at the value of 2,6 bar (0,26 MN/m²), the maintenance of this pressure until the pressure into autoclave decreases to 130° C., followed by the pressure adjustment at the value of 2 bar (0,2 MN/m²), the maintenance of this pressure until the temperature decreases to 120° C., followed by the pressure adjustment at the value of 1,3 bar (0,13 MN/m²), the maintenance of this pressure until the temperature decreases to 110° C., followed by the pressure adjustment at the value of 0,45 bar (0,045 MN/m²) and the maintenance of this pressure until the temperature decreases to 100° C., when the pressure into the autoclave is equalized with the atmospheric pressure.

8. Proceeding conformable to claim 1, characterized by the fact that the autoclaving phase with the continuous adjustment of the pressure into the autoclave is made by the continuous decrease of the pressure from the value of 2,6 bar (0,26 MN/m²) until the value of the atmospheric pressure, so that, between the saturation temperature of the steam corresponding to the pressure in the autoclave and the temperature in autoclave, it would remain a difference of minimum 10-15° C.

9. Proceeding conformable to claim 1, characterized by the fact that by the fine grinding of the semiproducts is obtained hydraulic binder named high strength hydraulic plaster, with slag content having values in the interval 23-33,5% and calcium sulfate alpha hemihydrate:slag ratio with values in the interval 1,2-1,9

10. Proceeding conformable to claim 1, characterized by the fact that by the autogenous grinding, pneumatic or/and mechanical classifying and fine grinding of the semiproducts are obtained more hydraulic binder assortments named much slag-high strength hydraulic plaster, high strength hydraulic plaster and high strength construction plaster.

11. High strength hydraulic plaster obtained conformable to claims 1,9 and 10, characterized by the fact that it have a slag content with values in the interval 23-33,5% and calcium sulfate alpha hemihydrate:slag ratio with values in the interval 1,2-1,9.

12. Much slag-high strength hydraulic plaster obtained conformable to claims 1 and 10, characterized by the fact that it have a slag content more of 33,5% and calcium sulfate alpha hemihydrate:slag ratio less of 1,2.

13. High strength construction plaster obtained conformable 1 and 10, characterized by the fact that it have a slag content less of 23% and calcium sulfate alpha hemihydrate:slag ratio more of 1,9.

14. Proceeding conformable to claim 1, characterized by the fact that the semiproducts for the making of the hydraulic binders from calcium sulfate alpha hemilhydrate and slag are obtained without fuel consumption and with the total suppression of the elimination of CO₂, SO₂, etc. in the environment.

15. The installation of achieving the proceeding defined to claim 1, characterized by the fact that is formed of semiproduct making installation and semiproduct processing installation, semiproduct making installation being constituted of slag pot (s) out of which liquid slag is diverted in an inclined slag runner (1), a bunker (2) for depositing the crushed gypsum rock, the drain (4) through which the gypsum rock is introduced in the liquid slag jet, an autoclave which is composed of tank (5) with thermic insulated walls, protection blindage and evacuation door (6) and lid (7) endowed with adjustment device (8) of the steam quantity evacuated in the atmosphere, measure and checking devices of the pressure (P) and temperature (T), the safety valve (9), the heat recuperator (10), the protection ring (11) and the conveyer (12) and semiproduct processing installation which is constituted from the silos (13), feeding and dosing equipment (14), the conveyer (T₁), the fine grinding mill (15), the conveyer (T₄), the bunkers (20), the autogenous mill (16), the classifier (17), the bunkers (18) with feeding and dosing equipment (19) the conveyers (T₂) and (T₃), the conveyer (T₅) and the packing equipment (21).
